(19) United States
(12) Patent Application Publication
(10) Pub. No.: US 2020/0114728 A1
(43) Pub. Date: Apr. 16, 2020

(54) AIR-HANDLING DEVICE FOR INFLUENCING AN AIR STREAM INTO THE INTERIOR OF A VEHICLE

(71) Applicant: Dr. Ing. h.c. F. Porsche Aktiengesellschaft, Stuttgart (DE)

(72) Inventors: Thomas Groschopf, Rutesheim (DE); Morten Goedecke, Stuttgart (DE); Jannik Steinbach, Woerth (DE)

(21) Appl. No.: 16/600,628

(22) Filed: Oct. 14, 2019

(30) Foreign Application Priority Data
Oct. 15, 2018 (DE) 10 2018 125 421.0

(51) Int. Cl. B60H 1/00; B60H 1/34

(52) U.S. Cl. CPC B60H 1/00871; B60H 1/00564; B60H 2001/00721; B60H 1/3421; B60H 1/00842

(57) ABSTRACT

An air-handling device for influencing an air stream into an interior of a vehicle includes an air duct having a duct entrance for inflow of the air stream and two component air ducts, each respective component air duct including a respective component duct exit for outlet of a respective component air stream in a respective component outlet direction. The two component air ducts have different component outlet directions. The air-handling device further includes a flow director mounted between the component air ducts and the air duct, the flow director configured to be movable between at least two variation positions for varying fractions of the air flow into the respective component air streams. The air-handling device additionally includes a flow adjustor configured to be movable between at least two adjustment positions.

### CROSS REFERENCE TO RELATED APPLICATIONS

This application claims benefit to German Patent Application No. DE 10 2018 125 421.0, filed Oct. 15, 2018, which is hereby incorporated by reference herein.

### FIELD

The present invention relates to an air-handling device for influencing an air stream into the interior of a vehicle, and to an aeration device for aerating an interior of a vehicle.

### BACKGROUND

It is known that vehicles are equipped with air-handling devices in order for the interior of the vehicle to be aerated, in particular to be heated or to be cooled. The air-handling devices are normally part of an overall aeration device having an air-conditioning unit, in order to provide an air stream. In the interior of the vehicle, introduction of the air stream in an oriented manner is often desired here. This applies in particular to so-called personal air flow devices, which are able to orient the air stream in the direction of the passengers in the interior of the vehicle. In the known solutions, for the orientation of the air stream when flowing out of such air-handling devices, use is normally made of a combination of an flow adjustor and an influencing flap. The orientation of the influencing flap can in this case be changed by the flow adjustor, by a mechanical lever in the simplest case. Consequently, during the flow around said influencing means, the air flow is deflected or diverted and the outflow direction from the outlet opening of the air-handling device is changed.

### SUMMARY

In an embodiment, the present invention provides an air-handling device for influencing an air stream into an interior of a vehicle. The air-handling device includes an air duct having a duct entrance for inflow of the air stream and two component air ducts, each respective component air duct including a respective component duct exit for outlet of a respective component air stream in a respective component outlet direction. The two component air ducts have different component outlet directions. The air-handling device further includes a flow director mounted between the component air ducts and the air duct, the flow director configured to be movable between at least two variation positions for varying fractions of the air flow into the respective component air streams. The air-handling device additionally includes a flow adjustor configured to be movable between at least two adjustment positions, the flow adjustor being operatively connected to the flow director for a movement of the flow director between the variation positions by a movement of the flow adjustor between the adjustment positions.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an air-handling device according to the invention;

FIG. 2 shows the air-handling device of FIG. 1 in an assembled state;

FIG. 3 shows a schematic illustration of the air-handling device of FIGS. 1 and 2;

FIG. 4 shows a further schematic illustration for the air-handling device of FIGS. 1 and 2;

FIG. 5 shows an air-handling device with a variation mechanism in a first variation position; and

FIG. 6 shows the air-handling device of FIG. 5 in a further variation position.

### DETAILED DESCRIPTION

A disadvantage of known air-handling devices having such adjustment flaps is that merely one limited adjustment is possible. In particular, due to the simple mechanical coupling between the flow adjustor and the adjustment flap, no or only a reduced influencing of the flow direction is possible in the limit ranges. Not least, the variation of the outlet direction is also optically visible, with the result that, according to the orientation of the air flow, different optical impressions at the air-handling device are formed.

The present invention provides for at least partially eliminating the disadvantages described above. In particular, the present invention improves the variation of a flow direction of an air-handling device in an inexpensive and simple manner.

According to the invention, air-handling devices for influencing an air stream into the interior of a vehicle are provided. For this purpose, the air-handling devices have an air duct with a duct entrance for inflow of the air stream. Furthermore, provision is made of at least two component air ducts, with in each case one component duct exit for the respective outlet of a component air stream, with mutually different component outlet directions. Between the component air ducts and the air duct, at least one variation means, i.e. a flow director, is mounted so as to be movable between at least two variation positions, for varying the flow fractions with the distribution of the air flow into the component air streams. Furthermore, provision is made of an adjustment means, i.e. a flow adjustor, which is mounted so as to be movable between at least two adjustment positions and is operatively connected to the flow director, for a movement of the flow director between the variation positions by a movement of the flow adjustor between the adjustment positions.

According to the invention, an air-handling device can therefore be based on the known concept of introducing an air stream into the interior of a vehicle in an oriented manner. However, according to the invention, it is then the case that the mechanical influencing of the air stream and the mechanical influencing of the orientation of the discharged air stream are decoupled from one another and introduced into the air-handling device at two different positions. This is ensured in that a static and preferably non-variable component outlet direction is predefined for each component duct exit of each component air duct. In this way, for at least two component air ducts, provision is made for a combination of two different component outlet directions at the two different component duct exits. As will be explained further below, said two component outlet directions influence one another, preferably mutually, and in particular can intersect and/or extend parallel to one another. In other words, the combination of the two component air streams from the component duct exits therefore gives rise to an overall air stream which, accordingly, also defines an overall outlet direction with the combination of the two component outlet directions.

In order then to vary the overall outlet direction, that is to say the direction which the combined overall air stream from the component air streams assumes, the combination of the flow adjustor and the at least one flow director is provided in the manner according to the invention. For the variation of the overall outlet direction, the flow adjustor has to be acted on with an adjustment movement by the user in the interior of the vehicle. In other words, the user moves the flow adjustor from a first adjustment position into a second adjustment position. The adjustment positions may in this case be defined positions, for example through the assumption of locking positions. However, it is self-evidently also conceivable that any desired number of adjustment positions, with continuous transition, permit continuous adjustment by way of the flow adjustor.

The fact that, in the manner according to the invention, an operative connection exists between the flow adjustor and the at least one flow director that the adjustment movement is converted into a variation movement. This means that, due to the adjustment movement and thus the movement of the flow adjustor from a first adjustment position into a second adjustment position, the flow director is likewise moved from a first variation position into a second variation position by way of the variation movement thus generated. By contrast to hitherto known solutions, however, the variation positions differ not with regard to the orientation of the air stream when flowing out of the air-handling device. Rather, the variation positions differ according to the invention in that they vary the fraction with which the overall air stream from the duct entrance is distributed between the individual component air ducts. In a first extreme position, the flow director can, for example, completely block off one of the component air ducts, with the result that the air stream exclusively enters the other component air duct. In a further extreme position, the flow director can be moved into a neutral position, with the result that both component air ducts are supplied with an equal fraction, that is to say with a 50/50 distribution, of the air stream. Self-evidently, in a third extreme position, it is also possible for the other component air duct to be opened, and the first component air duct to be closed, by way of the flow director. As discussed already in relation to the flow adjustor, individual variation positions may be defined, for example by way of locking, pre-defined and assumed. However, advantages may be achieved if the individual variation positions merge into one another continuously such that a continuous adjustment by way of a continuous adjustment movement also makes it possible to produce a continuous variation by way of a continuous variation movement by the flow director.

As is evident from the preceding discussion, it is then possible for the distribution of an overall air stream between the at least two component air ducts to be varied. It is therefore possible to differentiate whether a 50/50 distribution, a 60/40 distribution or a 90/10 distribution, as an example, is to be assumed between the component air ducts. This variation of the air quantities leads to the fixedly set and different component outlet directions of the two component duct exits then being supplied with an in each case different quantity of air. Due to the fixedly set component outlet directions but the variation of the corresponding quantity of air, which flows out along the respective component outlet direction, the variation of the flow director via the variation movement accordingly results also in the overall outlet direction, which is established as the combination of the individual component outlet directions, being varied. For this purpose, a more detailed explanation will in particular be given later with reference to the figures.

Thus, proceeding from the known solutions, the adjustment movement is then completely decoupled from the mechanical influencing of the outlet direction. This firstly produces the advantage that the flaps or the flow director can be mounted toward the rear such that, due to a mechanical operative connection, the flow director come to be situated outside the view of the passenger in the interior of the vehicle. Furthermore, due to the mechanical decoupling between the variation of the outlet direction as overall outlet direction and the movement of the flow director, a more elongate embodiment having greater freedom of design becomes possible. The overall system of the air-handling device can consequently be incorporated into the overall concept of the vehicle in a more compact manner and with greater freedom of design.

A further advantage is achievable if, in an air-handling device according to the invention, the flow adjustor is arranged at the component duct exits, in particular around the component duct exits. Here, particularly simple and comfortable operation is involved. In particular, the flow adjustor is arranged around the component duct exits over the circumference or over the full circumference. Such a circumferential, in particular circular, arrangement leads to a particularly simple and inexpensive configuration and furthermore leads to intuitive operability of the flow adjustor being achievable. This applies in particular if a correlation of the adjustment movement with the variation of the overall outlet direction is provided.

It is furthermore advantageous if, in an air-handling device according to the invention, the flow adjustor is mounted so as to be pivotable between the at least two positions for a pivoting adjustment movement. A pivoting adjustment movement is likewise a particularly simple and inexpensive configuration of the intuitive operability of the flow adjustor. In this case, it is possible for example for pivoting toward the front or toward the rear or lateral pivoting to the left or to the right to be provided. The pivoting movement and the pivoting direction preferably correlate here with the variation of the overall outlet direction which is thus produced. In other words, pivoting of the flow adjustor from the top downward, that is to say toward the front, will lead to a shift or variation in the overall outlet direction likewise from the top downward. A variation or pivoting of the flow adjustor from left to right can lead, with the direct correlation with the variation movement, to the overall outlet direction then being varied in the same direction to the left or to the right. Use may be made for example of a cardan joint, a ball joint or some other mechanical bearing device as a mounting for said pivoting movement.

Further advantages are achievable if, in an air-handling device according to the invention, the component outlet directions of at least two component duct exits, in particular of all the component duct exits, intersect. Preferably all the component outlet directions intersect at a point or in an section for all the directions. The influencing of the overall outlet direction is significantly improved by the intersection situation. However, a parallel or guided-along orientation of the individual component outlet directions is in principle also possible, with the result that fluid dynamic influencing of the adjacent stream through entrainment and swirling with the adjacent stream is able to be provided.

It may furthermore be advantageous if, in an air-handling device according to the invention, the sum of the flow cross sections of the component air ducts corresponds, or substantially corresponds, to the flow cross section of the air duct. The sum of the flow cross sections is in this case the sum of the free flow cross sections, that it to say the cross-sectional areas of the component air ducts and of the air duct, which is available to the air flow or the component air stream. In the case of full opening of the flow director, this leads to a reduced or minimized pressure loss. In particular, a distinction between different flow speeds is avoided. This preferably leads to the avoidance or reduction of stagnation zones or zones of elevated pressure or reduced flow speed in the air-handling device.

A further advantage is achievable if, in an air-handling device according to the invention, the flow cross sections of the component air ducts are identical or substantially identical. This leads to an identical or substantially identical effect on all the component air ducts. The design and the production can also be improved by the identicalness of the flow cross sections and reduced with regard to costs. Preferably, the flow cross sections are in this case constant or substantially constant over the course. Preferably, however, in the region of the outlet, cross-sectional narrowing can provide a nozzle function for the outlet of the component air stream.

It may likewise be advantageous if, in an air-handling device according to the invention, at least four component air ducts and at least two flow director are provided, wherein the at least two flow director are arranged one after the other in the flow direction of the air stream. The individual flow director are, as already discussed, preferably of flap-like form here. The arrangement one after the other or one behind the other further promotes the elongate extent with small diameter for the entire air-handling device. Consequently, the advantages according to the invention of the compactness are likewise achievable in the case of more than two component air ducts too. Here, the compact construction with greater freedom of design can also be achieved in complex flow situations with a plurality of component air ducts.

It is likewise advantageous if, in an air-handling device according to the invention, the flow adjustor, as a joint flow adjustor, moves the at least two flow director between the variation positions by way of an adjustment movement. This allows provision for the complexity in the adjustment with two or more flow director by way of still intuitive and simplified movement of the adjustment movement, since the joint flow adjustor, as it were, combines the flow director in terms of technical adjustment as the sole flow adjustor here. The flow adjustor is thus preferably coupled via separate mechanical coupling devices which are specific to the flow director.

It may likewise be advantageous if, in an air-handling device according to the invention, each adjustment position correlates with a unique variation position by way of the mechanical operative connection. This unique correlation is, as it were, specific between adjustment position and variation position, and so preferably intuitive operation is made possible. The coupling, for example via mechanical lever systems, can predefine this unique mechanical operative connection.

The present invention likewise relates to an aeration device for aerating an interior of a vehicle, having at least one air-handling device according to the invention. An aeration device according to the invention thus yields the same advantages as have been discussed in detail with respect to an air-handling device according to the invention. Such an aeration device may for example have a ventilation device, a joint aeration duct, an air-conditioning system, a heater or else further components.

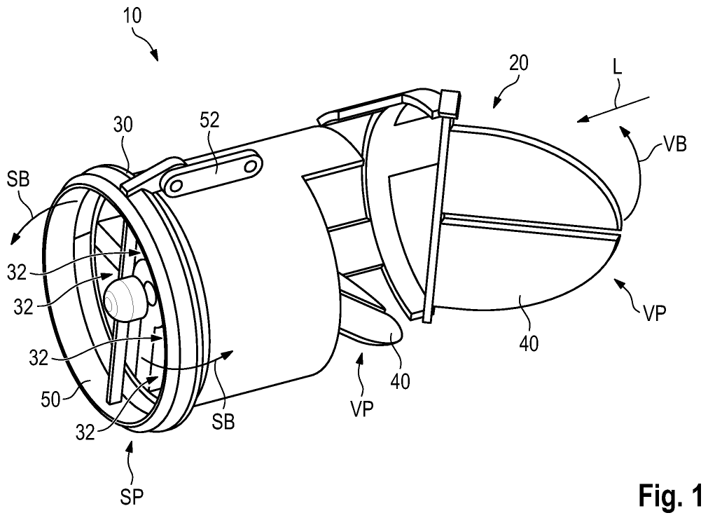

In FIG. 1, an illustration schematically shows how an air-handling device 10 can be configured. In this embodiment, provision is made at the outflow of an flow adjustor 50 with a circular, peripheral configuration. Here, said circular flow adjustor 50 surrounds four component duct exits 32 of four component air ducts 30. In order to vary the individual component air ducts 30 in relation to the fraction of the air stream L, two flow director 40 in the form of flaps are arranged here one after the other along the air stream L. In the illustrated position, the two flow director 40 are each situated in a variation position VP, which influences the air stream L in the distribution between the four component air ducts 30. In order to vary the variation positions VP, it is necessary for these to be moved along a variation movement VB. In order for this to be carried out, provision is made here of mechanical coupling means 52 which provide a mechanical operative connection between an adjustment movement SB along the arrows as per FIG. 1 and a correlating variation movement VB of the flow director 40.

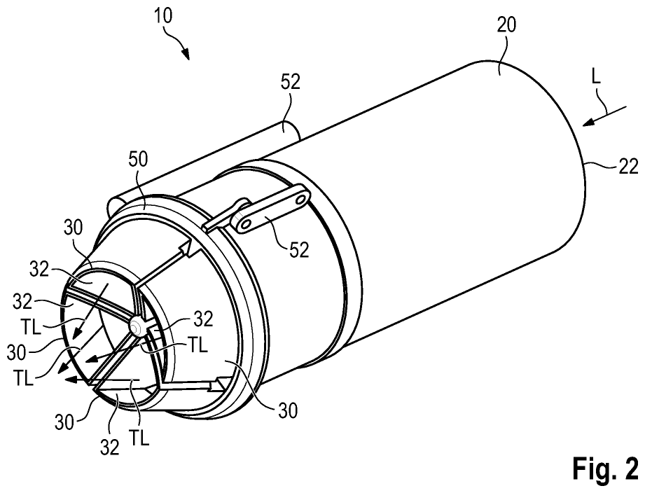

FIG. 2 shows an assembled state with the surrounding air duct 20 and with the duct entrance 22. Arranged therein are the flow director 40 arranged one after the other as per FIG. 1. The outlet along the respective component air streams TL out of the respective component duct outlet 32 can furthermore be seen in FIG. 2. The two coupling devices 52 for the flow adjustor 50 can also be seen here, which coupling devices are able to convert the corresponding adjustment movement SB into a corresponding variation movement VB.

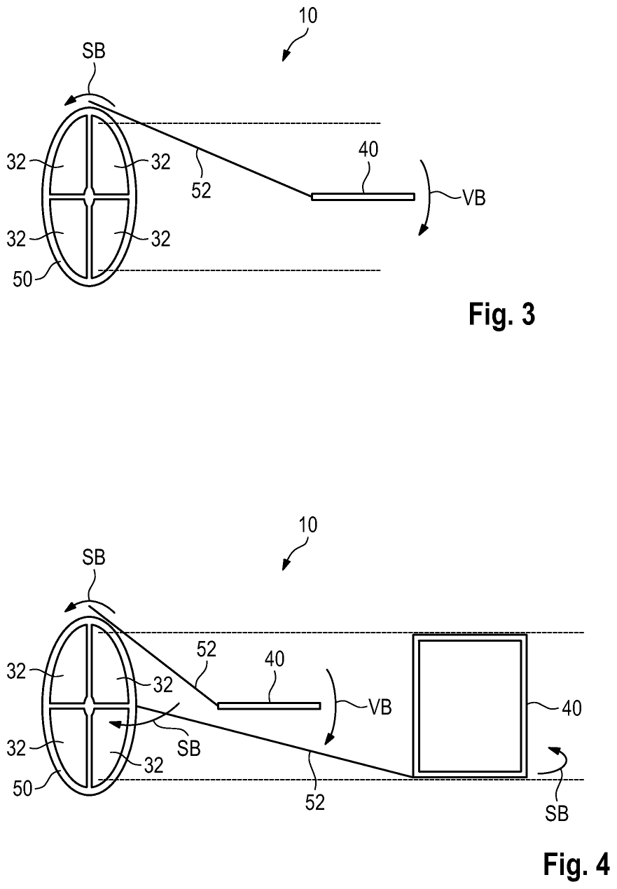

FIGS. 3 and 4 show how adjustment movements SB can be carried out. FIG. 3 provides an embodiment of the air-handling device 10 with a simple assignment, specifically a simple flow director 40. A pivoting movement as an adjustment movement SB toward the front, that is to say to the left in FIG. 3, results in the corresponding variation movement VB being transferred to the flow director 40 via the coupling device 52. This allows provision of a variation in the distribution of the air stream L as in the manner discussed. FIG. 4 then allows, by way of a joint flow adjustor 30, the adjustment movement SB along two directions, specifically from the top downward, or toward the front, in a pivoting manner and, in a second way, toward the left or right in a pivoting manner. For these two separate pivoting movements SB, provision is also made of separate coupling devices or coupling means 52, which convert this respective pivoting movement as adjustment movement SB into separate variation movements VB of separate flow director 40 which are arranged one after the other.

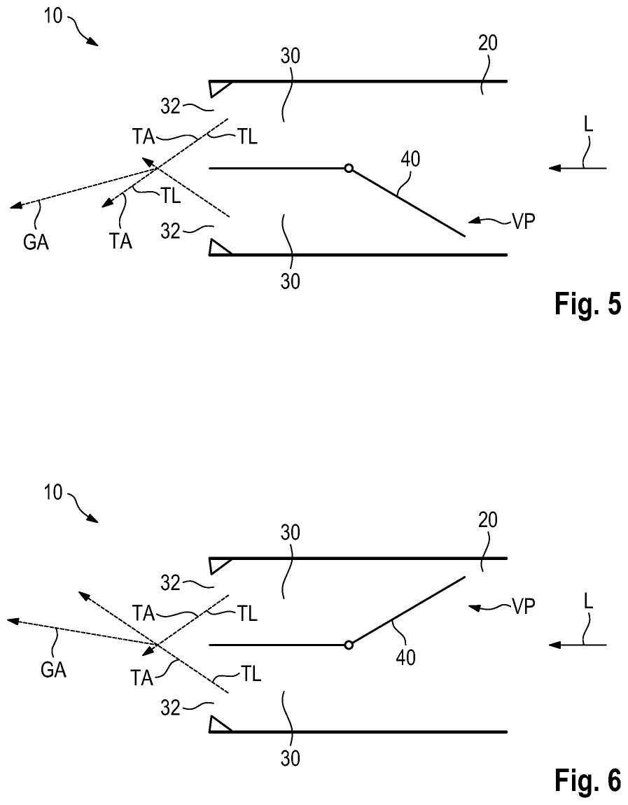

Illustrated in FIGS. 5 and 6 are the two variation positions VP and the correlation which is established in the different variation positions VP for the overall outlet direction GA. In FIG. 5, a larger fraction of the air stream L will enter the upper component air duct 30. Here, the upper component outlet direction TA intersects the bottom component outlet direction TA. The different length of the arrows of the component air streams TL illustrates the different quantity through the varied distribution by way of the flow director 40. The fact that the larger quantity is conducted downward along the upper component outlet direction TA means that the combination of the component air streams TL of differing intensities results in a slightly downwardly inclined overall outlet direction GA being established. If, conversely, an overall outlet direction GA toward the top is desired, then, as per FIG. 6, the flow director 40 is brought into another variation position VP such that a larger fraction of the air stream L then enters the lower component air duct 30. The correspondingly varied quantity of component air flow TL, as indicated again by the different arrow lengths, results in the direction of the overall outlet direction GA which is established being shifted toward the top, as is illustrated in FIG. 6.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An air-handling device for influencing an air stream into an interior of a vehicle, the air-handling device comprising:
an air duct having a duct entrance for inflow of the air stream and two component air ducts, each respective component air duct including a respective component duct exit for outlet of a respective component air stream in a respective component outlet direction, wherein the two component air ducts have different component outlet directions;
a flow director mounted between the component air ducts and the air duct, the flow director configured to be movable between at least two variation positions for varying fractions of the air flow into the respective component air streams; and
a flow adjustor configured to be movable between at least two adjustment positions, the flow adjustor being operatively connected to the flow director for a movement of the flow director between the variation positions by a movement of the flow adjustor between the adjustment positions.

2. The air-handling device as claimed in claim 1, wherein the flow adjustor is arranged at the component duct exits.

3. The air-handling device as claimed in claim 1, wherein the flow adjustor is configured to be pivoted between the at least two adjustment positions for a pivoting adjustment movement.

4. The air-handling device as claimed in claim 1, wherein the component outlet directions of the two component air ducts intersect.

5. The air-handling device as claimed in claim 1, wherein a sum of flow cross sections of the two component air ducts corresponds to a flow cross section of the air duct.

6. The air-handling device as claimed in claim 1, wherein respective flow cross sections of each respective one of the two component air ducts are identical.

7. The air-handling device as claimed in claim 1, further comprising:
at least two additional component air ducts; and
a second flow director,
wherein the flow director and the second flow director are arranged one after the other in a flow direction of the air stream.

8. The air-handling device as claimed in claim 7, wherein the flow adjustor is a joint flow adjustor configured to move the flow director between the variation positions and the second flow director through second variation positions by an adjustment movement.

9. The air-handling device as claimed in claim 1, wherein each adjustment position correlates with a unique variation position by a mechanical operative connection.

10. An aeration device for aerating an interior of a vehicle, having at least one air-handling device according to claim 1.
